(19) United States
(12) Patent Application Publication
(10) Pub. No.: US 2007/0067793 A1
(43) Pub. Date: Mar. 22, 2007

(54) Portable storage device provided with a digital key

(75) Inventors: Hon-Wai NG, Hsinchu Hsien (TW); Sheng-Yu Chang, Hsinchu Hsien (TW)

Correspondence Address: BRUCE H. TROXELL, SUITE 1404, 5205 LEESBURG PIKE, FALLS CHURCH, VA, 22041, US

(73) Assignee: Phison Electronics Corporation

(21) Appl. No.: 11/227,192

(22) Filed: Sep. 16, 2005

(51) Int. Cl. H04N 7/16

(52) U.S. Cl. 725/25

(57) ABSTRACT

A portable storage device includes a plug-and-play medium for connecting with a digital set-top box, a digital key for access a TV broadcasting system via the digital set-top box so as to obtain TV performance; and a recording unit for storing files or content concerning the TV performance.

### FIELD OF THE INVENTION

The invention relates to a portable storage device, more particularly to a portable storage device for use in digital TV broadcasting system. The portable storage device is provided with a digital key for identifying a user's identification during access into the TV broadcasting system.

### BACKGROUND OF THE INVENTION

As the communication between cellular phones is operated digitally, the broadcast of TV performance is also in the trench to change from analog system to digital system, since the latter system provides clearer visibility of the images and consumes lower power source. In the near future, one can access to the TV performance via the network from any places, such as a MRT station, a bus stop, an airport and a drawing room. By carrying portable notebook computer along with oneself, the user can access the information as well as TV entertainment.

In order to form a multimedia network, a DVB (digital Video Broadcasting) project is established lately in Europe to design global standards for global delivery of digital TV and data services. The consumers can enjoy network TV performance, commercial information, and instant news over the DVB project.

Referring to FIG. 1, a conventional digital TV broadcasting system is shown to include a multiple system operator 120 coupled to a set-top box 14 of a TV set via a line connection. Meanwhile, the broadcast can be transmitted via the digital video broadcasting station 150 to the set-top box 14 of the TV set, an individual PDA and a roaming user 180 (such as portable notebook computer). In addition, the broadcast from the digital video broadcasting station 150 can be transmitted to the roaming user 180 via the satellite 170. On the other hand, the broadcast from the digital video broadcasting station 150 can be transmitted to the roaming user 180 via the local broadcasting station 160. Alternately, the broadcast can be transmitted via the network accessory (not shown) to the roaming users. Therefore, the digital video broadcasting system provides a wider range of TV services when compared to the analog system.

In the conventional TV broadcast system, the user generally watches the TV performance at a fixed terminal (such as home or office). The service provider is capable of easily charging the user according to the contents of the TV performance being watched. The advent of digital video broadcasting system permits the user to watch the TV performance from anywhere, such as a railway station, a MRT station, or outdoors. In case the service provider is unable to identify the particular user, charging the user according to the contents of the TV performance being watch will be difficult to account for.

Generally, most the TV performance we watch at home are charged on monthly basis. As the advance of digital video broadcasting system, the consumer can select a TV program according to the taste, and later watch the selected performance (such as current movies) over the TV set. The service provider will charge the consumers according to the contents of the watched performance. The proper amount of charge can be calculated only when the service provider can identify the individual consumer.

As for the service provider (such as digital video broadcasting system), it is very important to identify the individual consumer so as to charge the latter according to the content of the TV performance being watched. Therefore, the service providers are in the trench to find a way for solving the problem of wrongly charging the consumer.

### SUMMARY OF THE INVENTION

The object of the present invention is to provide a portable storage device for use in digital TV broadcasting system. The portable storage device is provided with a digital key for identifying a user's identification during access into the TV broadcasting system.

A portable storage device of the present invention includes: a plug-and-play medium for connecting with a digital set-top box; a digital key for access to a TV broadcasting system via the digital set-top box so as to obtain TV performance; and a recording unit for storing files or content concerning the TV performance.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 illustrates a conventional digital video broadcasting system;

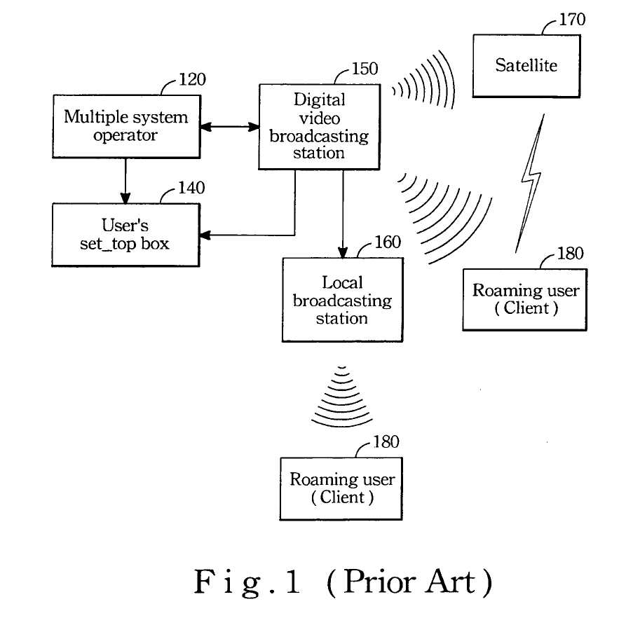

FIG. 2 is an embodiment of a portable storage device of the present invention;

FIG. 3A to 3C respectively illustrate the steps how the user of the portable storage device of FIG. 2 access the digital video broadcasting system.

### DETAILED DESCRIPTIONS OF THE PREFERRED EMBODIMENT

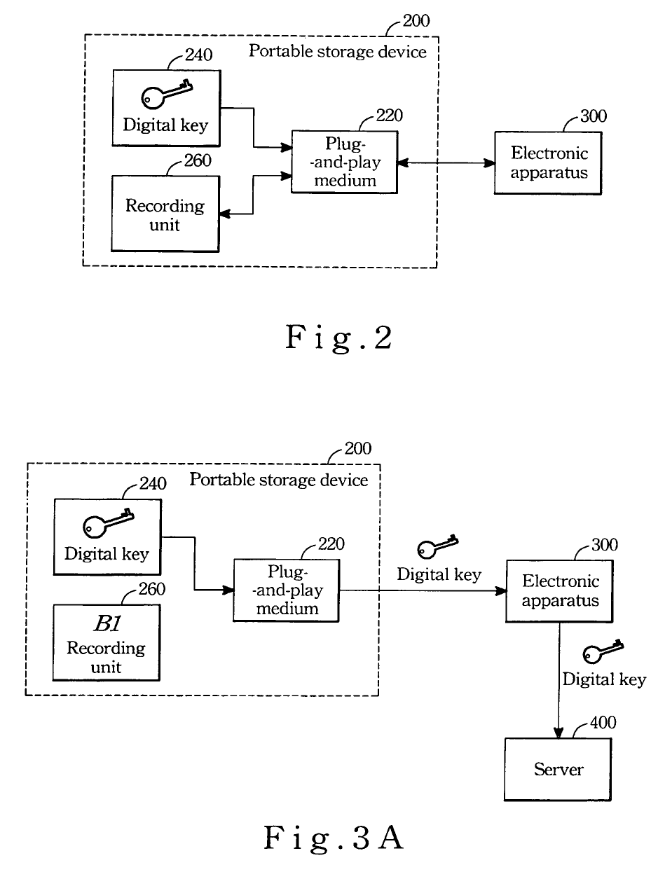

FIG. 2 illustrates an embodiment of a portable storage device 200 according to the present invention is shown to include a plug-and-play medium 220, a digital key 240 and a recording unit 260. The plug-and-play medium 220 is used for connecting to an electronic apparatus 300, such as a digital set-top box, a notebook computer or a PDA (personal digital assistant). In order to achieve the plug-and-play purposes, USB (Universal Serial Bus) ports presently available in the market can serve as the plug-and-play medium 220.

By virtue of the plug-and-play medium 220, the electronic apparatus 300 is able to identify the digital key 240 of the portable storage device 220, thereby permitting the latter to have access to the digital video broadcasting system. Under this condition, files or content concerning the TV performance can be recorded in the recording unit 260 of the portable storage device 200. In order to prevent untimely and undesired alteration in the digital key 240, the latter is burned into a ROM (Read Only Memory), thereby avoiding the occurrence of a denial of the portable storage device 200 to the digital video broadcasting system. Once the digital key 240 is burned in, as the ROM, alteration and amendment thereof will never happen regardless of discrepancy in the protocols.

Once the plug-and-play medium 220 is coupled to the electronic apparatus 300, the user (client) can have access to the digital video broadcasting system. The files or content (B1) recorded in the recording unit 260 may include a bill showing the charged fees for watching paid TV performance (such as movies). The bill may change according to the content of the TV performance being watched by the user of the portable storage device 200 of the present invention. In one embodiment of the present invention, a flash compact memory card serves as the recording unit 260.

The aforesaid digital key 240 permits a specific individual person to have access to the digital video broadcasting system. In other words, the digital key 240 is authorized to the specific individual person, no other person is allowed to have access to the TV performance. In one embodiment of the prevent invention, a public key serves as the digital key 240 to identify the specific individual person. Meanwhile, the user must also keyin a set of PIN number in order to certify that he or she is the legal person to have access to the TV performance.

Therefore, the digital key 240 and the set of PIN number are inevitable once the user wishes to have access to the TV performance. Since each digital key 240 is encoded with a set of specific numbers (including complex and large packet of hash value for encryption). In case, the server (the digital video broadcasting system or web server) finds there are two digital keys 240 using the same set of specific numbers, the server may deny access of the second person using the set of specific number under the same environment. In addition, the set of specific numbers in the digital key 240 will protect the files or content (B1) in the recording unit 260 from being decoded or encrypted. In other words, any person without the initial digital key has access to the content (B1) in the portable storage device 200 of the present invention will read the text as nonsense. Thus, no body can obtain the content (B1) stored in the recording unit 260.

In order to facilitate the user to easily see the content (B1), the latter can be displayed over the TV set once the portable storage device 200 is coupled to the set-top box of the TV set. As shown in FIG. 2, the portable storage device 200 further includes a firmware (not shown) which is initialized in such a manner to have access to the recording unit 260 in order to transmit the content (B1) to the TV set via the set-top box such that the content (B1) is displayed over the TV set. Therefore, in order to display the content (B1) in the portable storage device 200 of the present invention, the operating system of a computer is not inevitably necessary, which, in turn, provides a wider and convenient use of the portable storage device 200 of the present invention.

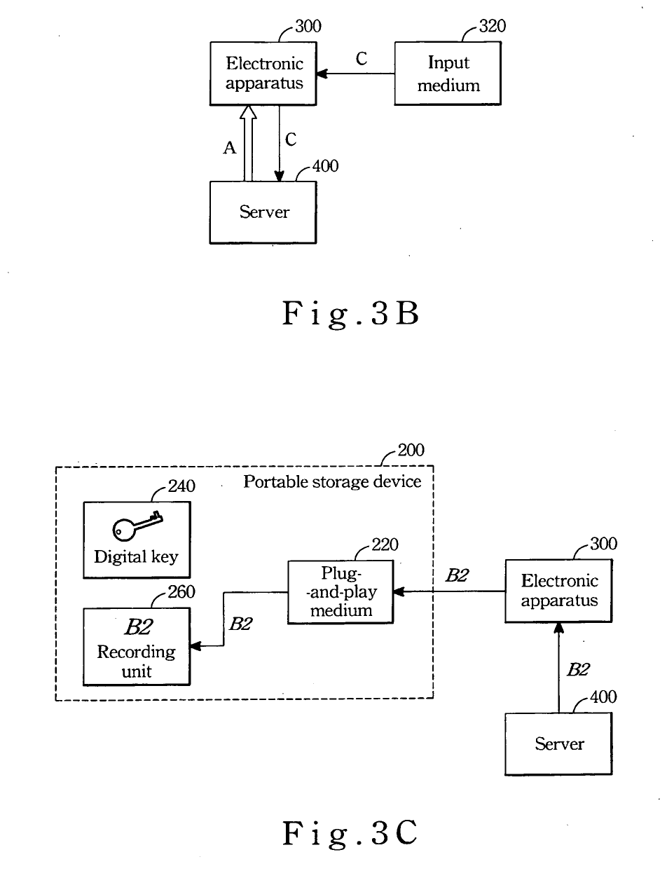

FIGS. 3A to 3C respectively illustrate the steps of coupling the portable storage device 200 to the electronic apparatus 300 for access the digital video broadcasting system. The digital video broadcasting system accordingly includes at least one electronic apparatus 300, a portable storage device 200 and a server 400 from which TV performance can be obtained. The electronic apparatus 300 is coupled to the server 400 so that the latter can transmit the TV performance to the electronic apparatus 300 so as to be displayed over the TV set. The portable storage device 200 is burned in with a digital key 240 for identifying the identification of the specific user.

As shown in FIG. 3A, once the portable storage device 200 is coupled to the electronic apparatus 300, the digital key 240 will be transmitted to the server 400 informing the identification of the specific user. In other words, the server 400 is capable of verifying the identification of the specific user through the digital key 240.

Referring to FIG. 3B, in order to confirm the identification of the specific user, the latter must also key in a set of PIN number (C) via an input medium 320 (such as plug-and-play medium). Only then, the user can have access to the TV servicing system for obtaining the TV performance (A). Due to restrict dimension of the portable storage device 200, the remote control of the set-top box, the keyboard of the notebook computer, the touch panel of the PDA can serve as the input medium 320.

As shown in FIG. 3C, once the portable storage device 200 is coupled to the server 400, the content B2 in recording unit of the portable storage device 200 is updated according to the TV performance being watched. The content B2 can be displayed over the TV set if required.

In summary, from the abovementioned paragraphs, the portable storage device 200 of the present invention when coupled to the digital video broadcasting system provides the following advantages:

(1) By virtue of the plug-and-play medium in the portable storage device 200, the user can have access to the TV performance from anywhere, for example, during a visit to friend. He can simply plug the storage device 200 into the set-top box of the TV set in the friend's drawing room in order to obtain the TV performance.

(2) Since the digital key 240 is burned into the portable storage device 200, the servicing system (the server) is capable of identifying the identification of the user. The user is charged according to the content of the TV performance being watched. No argument will be resulted since the user pays only for the exact amount fee he watched.

(3) Due to presence of the recording unit 260, the charged fees are recorded therein so that the user of the portable storage device 200 can clearly know how much amount of fees is being charged so far. He or she can control the expense caused due to watching the paid TV performance.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A portable storage device comprising:
a plug-and-play medium for connecting with a digital set-top box;
a digital key for access to a TV broadcasting system via the digital set-top box so as to obtain TV performance; and
a recording unit for storing files or content concerning said TV performance.

2. The portable storage device according to claim 1, further comprising a firmware which is initialized in such a manner to have access said recording unit in order to transmit said files to a TV set via said set-top box so that said files are to be displayed over said TV set.

3. The portable storage device according to claim 1, wherein said plug-and-play medium includes USB connecting ports.

4. The portable storage device according to claim 1, further comprising a ROM (read-only memory) for storing said digital key.

5. The portable storage device according to claim 1, wherein said recording unit is a Flash Compact memory.

6. The portable storage device according to claim 1, wherein said digital key is a Public Key.

7. The portable storage device according to claim 1, wherein said files stored in said recording unit includes a bill showing charged fees for watching paid TV performance.

8. A digital TV broadcasting system comprising:
a set-top box;
a portable storage device including a digital key burned therein for identifying a specific user's identification once said portable storage device is coupled to said set-top box; and
a server capable of obtaining said digital key via said set-top box for identifying the specific user's identification in order to transmit files concerning TV performance into said portable storage device.

9. The digital TV broadcasting system according to claim 8, further comprising a plug-and-play medium for coupling to said set-top box and a set of PIN number, said set of PIN number permitting said server to identify the user's identification in order to allow download of said files by the user after confirmation of the user's identification.

10. The digital TV broadcasting system according to claim 9, wherein said files includes a bill showing charged fees for watching paid TV performance.
